(19) United States
(12) Patent Application Publication
(10) Pub. No.: US 2018/0053611 A1
(43) Pub. Date: Feb. 22, 2018

(54) LIGHT COLOR CHANGEABLE ILLUMINATED KEYBOARD

(71) Applicant: PRIMAX ELECTRONICS LTD., Taipei (TW)

(72) Inventors: Che-Wei Yang, Taipei (TW); Chun-Yuan Liu, Taipei (US)

(21) Appl. No.: 15/360,150

(22) Filed: Nov. 23, 2016

(30) Foreign Application Priority Data
Aug. 19, 2016 (TW) 105126577

(51) Int. Cl. H01H 13/83; H01H 13/7065

(52) U.S. Cl. CPC H01H 13/83; H01H 13/7065; H01H 2219/054; H01H 2219/039; H01H 2219/062; H01H 2219/048

(57) ABSTRACT

A light color changeable illuminated keyboard includes a circuit layer, plural keys, a switching key, a bicolor light-emitting element and a control unit. The plural keys and the switching key are disposed on the circuit layer. The bicolor light-emitting element is located under the plural keys. The bicolor light-emitting element selectively emits a first color light or a second color light. The control unit is electrically connected with the switching key and the bicolor light-emitting element. If the switching key is pressed down when the bicolor light-emitting element emits the first color light, a pressing signal is generated. In response to the pressing signal, the color light emitted by the bicolor light-emitting element is switched from the first color light to the second color light under control of the control unit.

### FIELD OF THE INVENTION

The present invention relates to a computer keyboard, and more particularly to a light color changeable illuminated keyboard.

### BACKGROUND OF THE INVENTION

Conventionally, a computer keyboard is equipped with light-emitting elements (e.g., light emitting diodes) under keys in order to achieve the lighting purpose. The light-emitting elements are installed within the keyboard to emit light beams to the surroundings. After the light beams pass through character regions of the keys, the character regions of the keys are illuminated. Consequently, even if the keyboard is used in a dim environment, the user can view the character regions of the keyboard clearly. That is, the keyboard with the light-emitting elements is more convenient to the user.

However, the conventional computer keyboard still has some drawbacks. For example, since the light beams from the light-emitting elements of the conventional computer keyboard usually have a single light color, the light beams passing through the character regions of the keys have the same light color. If a key comprises plural character regions, the plural character regions are illuminated simultaneously. That is, the character regions of the same key cannot be selectively illuminated or not illuminated. Consequently, when the keyboard is used in a dim environment, the user is readily confused about the illuminated characters regions.

In other words, the conventional technologies need to be further improved.

### SUMMARY OF THE INVENTION

For solving the drawbacks of the conventional technology, the present invention provides a light color changeable illuminated keyboard. The user can switch the color light of the illuminated keyboard according to the practical requirements. Moreover, the character regions of the same key can be selectively illuminated or not illuminated. Consequently, the specified character regions can be recognized more easily.

In accordance with an aspect of the present invention, there is provided a light color changeable illuminated keyboard. The light color changeable illuminated keyboard includes a circuit layer, a supporting plate, plural keys, a bicolor light-emitting element, a switching key and a control unit. The supporting plate is located under the circuit layer. The plural keys are located over the circuit layer and connected with the supporting plate. Each of the plural keys includes a keycap, a light-transmission part, a connecting element and an elastic element. The keycap is located over the circuit layer. The light-transmission part is formed on a top surface of the keycap. The keycap is connected with the supporting plate through the connecting element. The bicolor light-emitting element is located below the key, and emits a first color light or a second color light continuously. The first color light or the second color light is outputted from the keycap through the light-transmission part. The switching key is disposed on the circuit layer to trigger the circuit layer to generate a pressing signal. The control unit is electrically connected with the switching key and the bicolor light-emitting element. When the pressing signal is received by the control unit, a switching signal is generated by the control unit and transmitted to the bicolor light-emitting element. If the switching key is pressed down when the first color light is continuously emitted by the bicolor light-emitting element, the pressing signal is transmitted from the switching key to the control unit, and the control unit generates the switching signal in response to the pressing signal. In response to the switching signal, the bicolor light-emitting element stops emitting the first color light and emits the second color light continuously.

In an embodiment, if the switching key is pressed down when the second color light is continuously emitted by the bicolor light-emitting element, the pressing signal is transmitted from the switching key to the control unit, and the control unit generates a restoring signal in response to the pressing signal. In response to the restoring signal, the bicolor light-emitting element stops emitting the second color light but emits the first color light continuously.

In an embodiment, if the control unit receives the pressing signal when the control unit detects that the first color light is continuously emitted by the bicolor light-emitting element, the control unit generates the switching signal, and the first color light is changed to the second color light in response to the switching signal. If the control unit receives the pressing signal when the control unit detects that the second color light is continuously emitted by the bicolor light-emitting element, the control unit generates the restoring signal and the second color light is restored to the first color light in response to the restoring signal.

In an embodiment, the first color light and the second color light have different colors.

In an embodiment, the light-transmission part includes a first color filtering pattern and a second color filtering pattern. The first color light is outputted from the keycap through the first color filtering pattern. The second color light is outputted from the keycap through the second color filtering pattern.

In an embodiment, the first color light is not allowed to pass through the second color filtering pattern, and the second color light is not allowed to pass through the first color filtering pattern.

In an embodiment, a color of the first color filtering pattern corresponds to a color of the first color light, and a color of the second color filtering pattern corresponds to a color of the second color light.

In an embodiment, the first color filtering pattern and the second color filtering pattern are formed on the keycap by a bicolor spraying process.

In an embodiment, the first color filtering pattern and the second color filtering pattern are formed on the keycap by a bicolor injection molding process.

In an embodiment, the bicolor light-emitting element is located below the key and disposed on the circuit layer, wherein the first color light or the second color light travels in a direction from the circuit layer to the key. After the first color light or the second color light passes through the light-transmission part, the first color light or the second color light is outputted from the keycap.

In an embodiment, the light color changeable illuminated keyboard further includes a light guide plate. The light guide plate is located under the supporting plate. The first color light or the second color light emitted by the bicolor light-emitting element is introduced into the light guide plate and guided to a region under the key. After the first color light or the second color light passes through the light-transmission part, the first color light or the second color light is outputted from the keycap.

In an embodiment, the supporting plate includes an opening. After the first color light or the second color light passes through the opening, the first color light or the second color light passes through the keycap.

In an embodiment, the bicolor light-emitting element is a bicolor light emitting diode.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outer appearance of a light color changeable illuminated keyboard according to an embodiment of the present invention;

FIG. 2 is a schematic exploded view illustrating a key of the light color changeable illuminated keyboard according to the embodiment of the present invention;

FIG. 3 is a schematic functional block diagram illustrating the relationship between the bicolor light-emitting element and the control unit in a normal working state;

FIG. 4 is a schematic functional block diagram illustrating the relationship between the bicolor light-emitting element and the control unit in a switching state;

FIG. 5 is a schematic functional block diagram illustrating the relationship between the bicolor light-emitting element and the control unit in a restoring state;

FIG. 6 schematically illustrates an optical path of the first color light corresponding to the key of the illuminated keyboard according to the first embodiment of the present invention;

FIG. 7 schematically illustrates an optical path of the second color light corresponding to the key of the illuminated keyboard according to the first embodiment of the present invention;

FIG. 8 is a schematic exploded view illustrating a key of a light color changeable illuminated keyboard according to a second embodiment of the present invention;

FIG. 9 schematically illustrates an optical path of the first color light corresponding to the key of the illuminated keyboard according to the second embodiment of the present invention; and

FIG. 10 schematically illustrates an optical path of the second color light corresponding to the key of the illuminated keyboard according to the second embodiment of the present invention.

### DETAILED DESCRIPTION OF THE PREFERRED EMBODIMENT

The present invention will now be described more specifically with reference to the following embodiments and accompanying drawings.

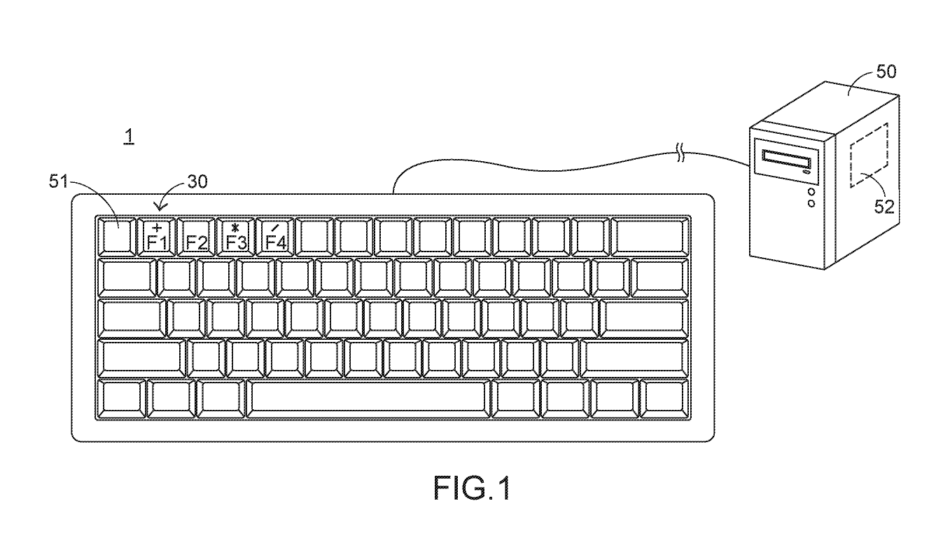

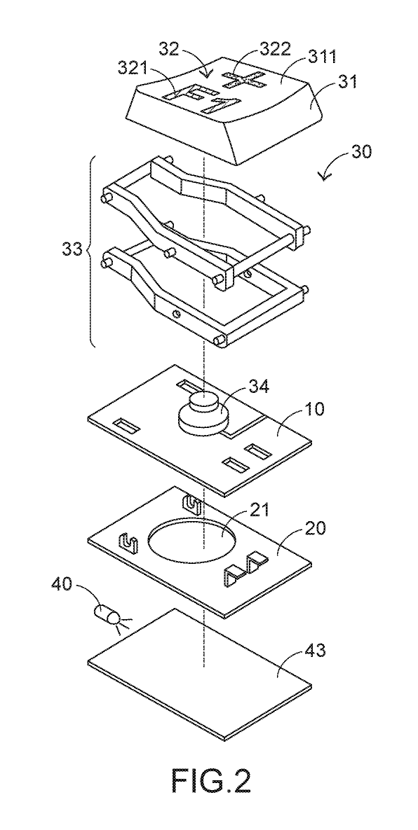

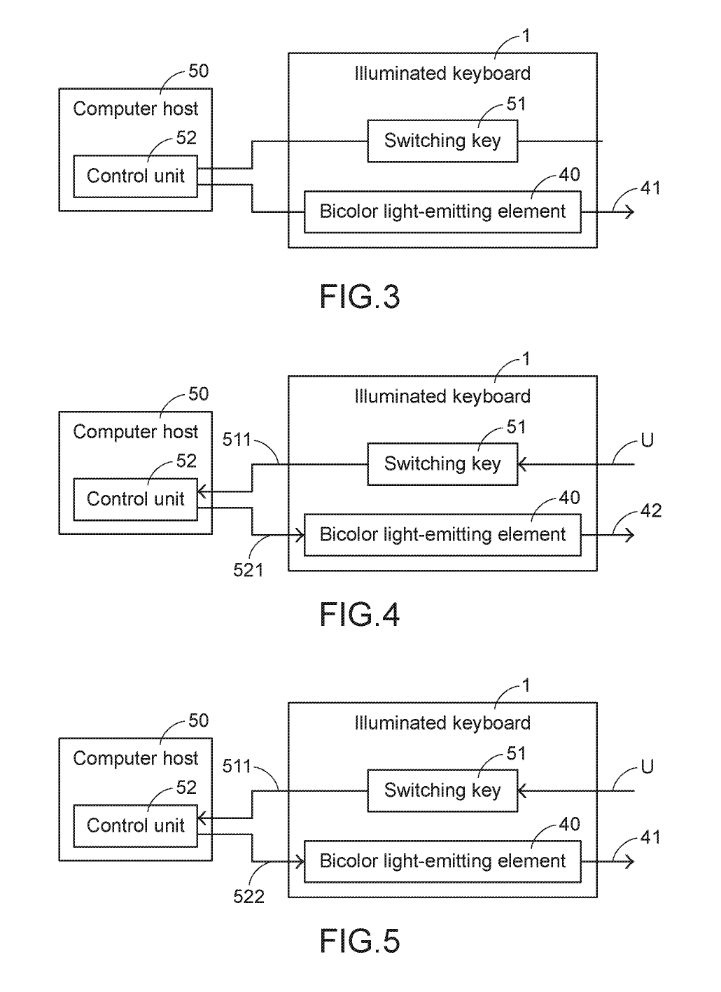

FIG. 1 is a schematic perspective view illustrating the outer appearance of a light color changeable illuminated keyboard according to an embodiment of the present invention. FIG. 2 is a schematic exploded view illustrating a key of the light color changeable illuminated keyboard according to a first embodiment of the present invention. As shown in FIGS. 1 and 2, the light color changeable illuminated keyboard 1 comprises a circuit layer 10, a supporting plate 20, plural keys 30, a bicolor light-emitting element 40, a switching key 51 and a control unit 52. The supporting plate 20 is located under the circuit layer 10. The plural keys 30 are located over the circuit layer 10 and connected with the supporting plate 20. When one of the plural keys 30 is pressed, the circuit layer 10 is triggered to generate a corresponding key signal (not shown). The bicolor light-emitting element 40 is below the plural keys 30. Moreover, the bicolor light-emitting element 40 emits a first color light 41 (see FIG. 3) or a second color light 42 (see FIG. 4) continuously. The switching key 51 is located over the circuit layer 10. When the switching key 51 is pressed down, a pressing signal 511 (see FIG. 4) is generated. The bicolor light-emitting element 40 and the switching key 51 are electrically connected with a control unit 52. In an embodiment, the control unit 52 is included in a computer host 50. After the pressing signal 511 is transmitted to the control unit 52, the control unit 52 generates a switching signal 521 (see FIG. 4) in response to the pressing signal 511. After the switching signal 521 is received by the bicolor light-emitting element 40, the color light emitted by the bicolor light-emitting element 40 is switched from the first color light 41 to the second color light 42 or switched from the second color light 42 to the first color light 41. It is noted that the control unit 52 is not restricted to be included in the computer host 50. For example, in another embodiment, the control unit is included in the main body of the illuminated keyboard.

In this embodiment, the illuminated keyboard 1 further comprises a light guide plate 43. The light guide plate 43 is located under the supporting plate 20. The light guide plate 43 is used for guiding the first color light 41 or the second color light 42. Moreover, the supporting plate 20 further comprises an opening 21. The first color light 41 or the second color light 42 is transmissible through the opening 21.

For succinctness, only one key 30 will be described as follows. Each key 30 comprises a keycap 31, a light-transmission part 32, a connecting element 33 and an elastic element 34. The light-transmission part 32 comprises a first color filtering pattern 321 and a second color filtering pattern 322. The keycap 31 is located over the circuit layer 10. The light-transmission part 32 is formed on a top surface 311 of the keycap 311. After the first color light 41 or the second color light 42 passes through the light-transmission part 32, the first color light 41 or the second color light 42 is outputted from the keycap 31. The connecting element 33 is located under the keycap 31. The keycap 31 is connected with the supporting plate 20 through the connecting element 33. The elastic element 34 is located under the keycap 31 and disposed on the circuit layer 10. When the keycap 31 is pressed down to push the elastic element 34, the elastic element 34 is moved downwardly to trigger the circuit layer 10 to generate the key signal. The bicolor light-emitting element 40 continuously emits the first color light 41 or the second color light 42 to the light guide plate 43. After the first color light 41 or the second color light 42 is transmitted within the light guide plate to the region under the key 30, the first color light 41 or the second color light 42 passes through the opening 21 of the supporting plate 20 and the circuit layer 10. After the first color light 41 or the second color light 42 passes through the first color filtering pattern 321 or the second color filtering pattern 322 of the light-transmission part 32, the first color light 41 or the second color light 42 is outputted from the keycap 31.

The procedures of switching the bicolor light-emitting element 40 under control of the control unit 52 will be illustrated with reference to FIGS. 3, 4 and 5. FIG. 3 is a schematic functional block diagram illustrating the relationship between the bicolor light-emitting element and the control unit in a normal working state. FIG. 4 is a schematic functional block diagram illustrating the relationship between the bicolor light-emitting element and the control unit in a switching state. FIG. 5 is a schematic functional block diagram illustrating the relationship between the bicolor light-emitting element and the control unit in a restoring state.

Please refer to FIG. 3. In the normal working state, the bicolor light-emitting element 40 emits the first color light 41. Since the switching key 51 of the illuminated keyboard 1 is not pressed down, the control unit 52 of the computer host 50 does not receive or generate the corresponding signals. Under this circumstance, the bicolor light-emitting element 40 emits the first color light 41 continuously.

Please refer to FIG. 4. When the switching key 51 is pressed down by a user U, the pressing signal 511 is generated. In response to the pressing signal 511, the control unit 52 of the computer host 50 generates the switching signal 521 to the bicolor light-emitting element 40. In response to the switching signal 521, the bicolor light-emitting element 40 stops emitting the first color light 41 but emits the second color light 42. After the bicolor light-emitting element 40 emits the second color light 42, if the switching key 51 is not pressed down by the user U and no other signal is received by the control unit 52, the bicolor light-emitting element 40 emits the second color light 42 continuously. Under this circumstance, the first color light 41 is not emitted.

FIG. 5 schematically illustrates a procedure of restoring the second color light 42 to the first color light 41. If the user U presses down the switching key 51 again to generate the pressing signal 511 when the bicolor light-emitting element 40 emits the second color light 42 continuously, the control unit 52 generates a restoring signal 522 in response to the pressing signal 511. In response to the restoring signal 522, the bicolor light-emitting element 40 stops emitting the second color light 42 but emits the first color light 41.

If the control unit 52 receives the pressing signal 511 when the control unit 52 detects that the first color light 41 is continuously emitted by the bicolor light-emitting element 40, the control unit 52 generates the switching signal 521, and the first color light 41 is changed to the second color light 42 in response to the switching signal 521. If the control unit 52 receives the pressing signal 511 when the control unit 52 detects that the second color light 42 is continuously emitted by the bicolor light-emitting element 40, the control unit 52 generates the restoring signal 522 and the second color light 42 is restored to the first color light 41 in response to the restoring signal 522. In other words, the light color from the bicolor light-emitting element 40 is switched between the first color light 41 and the second color light 42 under control of the control unit 52.

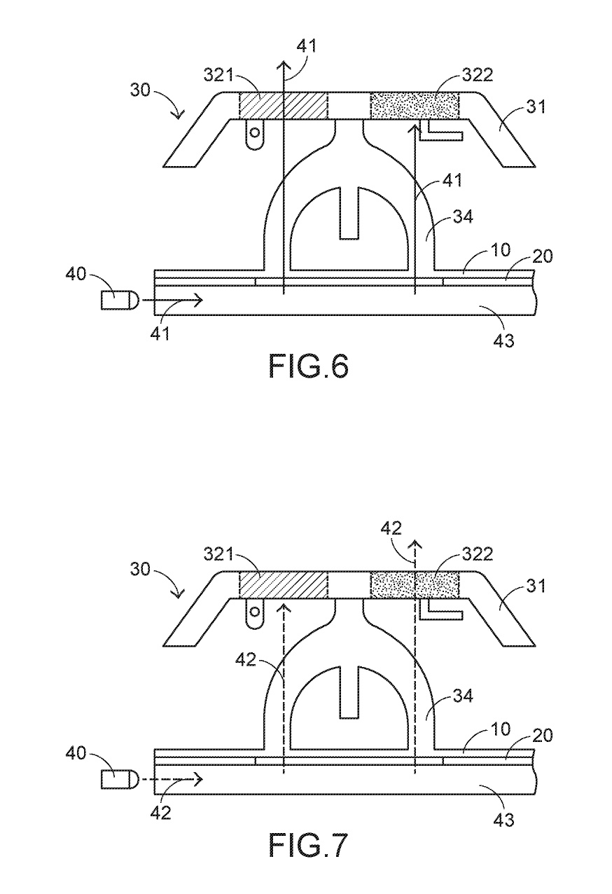

The procedure of allowing the first color light 41 or the second color light 42 to be outputted from the key 30 will be described as follows. FIG. 6 schematically illustrates an optical path of the first color light corresponding to the key of the illuminated keyboard according to the first embodiment of the present invention. FIG. 7 schematically illustrates an optical path of the second color light corresponding to the key of the illuminated keyboard according to the first embodiment of the present invention. As shown in FIG. 6, the first color light 41 is outputted from the key 30. As shown in FIG. 7, the second color light 42 is outputted from the key 30. The first color light 41 and the second color light 42 have different colors. Preferably, the colors of the first color light 41 and the second color light 42 are complementary colors. In an embodiment, the first color light 41 has a red color, and the second color light 42 has a green color. In another embodiment, the first color light 41 has a yellow color, and the second color light 42 has a blue color. The color of the first color filtering pattern 321 of the light-transmission part 32 corresponds to the color of the first color light 41. The color of the second color filtering pattern 322 of the light-transmission part 32 corresponds to the color of the second color light 42. Consequently, the first color light 41 is outputted from the keycap 31 through the first color filtering pattern 321, and the second color light 42 is outputted from the keycap 31 through the second color filtering pattern 322.

Please refer to FIG. 6 again. The first color light 41 emitted by the bicolor light-emitting element 40 is introduced into the light guide plate 43 and guided to the region under the key 30. Then, the first color light 41 travels to the region under the keycap 31 through the supporting plate 20 and the circuit layer 10. Since the color of the first color filtering pattern 321 on the keycap 31 corresponds to the color of the first color light 41, the first color light 41 is outputted to the surroundings through the first color filtering pattern 321. Under this circumstance, the first color filtering pattern 321 is illuminated. Since the color of the second color filtering pattern 322 and the color of the first color light 41 are complementary, the first color light 41 is absorbed by the second color filtering pattern 322. Moreover, since the first color light 41 is not allowed to pass through the second color filtering pattern 322, the second color filtering pattern 322 is not illuminated. Please refer to FIG. 7 again. The second color light 42 is emitted by the bicolor light-emitting element 40. Since the color of the second color filtering pattern 322 corresponds to the color of the second color light 42, the second color light 42 is outputted to the surroundings through the second color filtering pattern 322. Under this circumstance, the second color filtering pattern 322 is illuminated. Since the color of the first color filtering pattern 321 and the color of the second color light 42 are complementary, the second color light 42 is absorbed by the first color filtering pattern 321. Moreover, since the second color light 42 is not allowed to pass through the first color filtering pattern 321, the first color filtering pattern 321 is not illuminated.

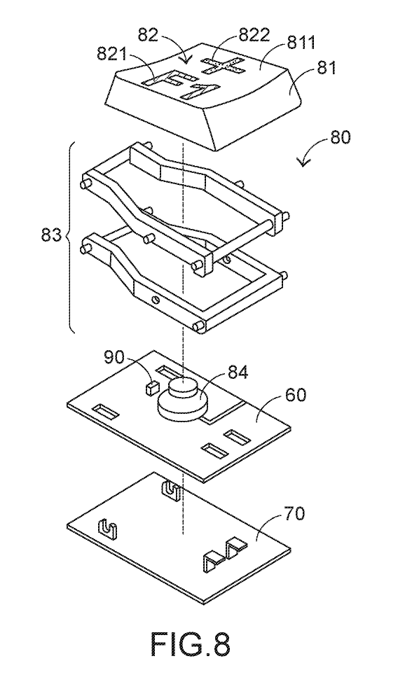

FIG. 8 is a schematic exploded view illustrating a key of a light color changeable illuminated keyboard according to a second embodiment of the present invention. As shown in FIG. 8, the light color changeable illuminated keyboard comprises a circuit layer 60, a supporting plate 70, plural keys 80 and a bicolor light-emitting element 90. For succinctness, only one key 80 is shown in the drawing. Each key 80 comprises a keycap 81, a light-transmission part 82, a connecting element 83 and an elastic element 84. The light-transmission part 82 comprises a first color filtering pattern 821 and a second color filtering pattern 822. The circuit layer 60 is located over the supporting plate 70. The plural keys 80 are located over the circuit layer 60. The bicolor light-emitting element 90 is located under the key 80 and disposed on the circuit layer 60. The connecting element 83 is located under the keycap 81. The keycap 81 is connected with the supporting plate 70 through the connecting element 83. The elastic element 84 is located under the keycap 81 and disposed on the circuit layer 60. In comparison with the first embodiment, the bicolor light-emitting element 90 of this embodiment is directly disposed on the circuit layer 60 that is under the keycap 81. Consequently, the color light emitted by the bicolor light-emitting element 90 travels in the upward direction and passes through the light-transmission part 82 of the keycap 81. The other components and the operations of the illuminated keyboard of this embodiment are similar to those of the first embodiment, and are not redundantly described herein.

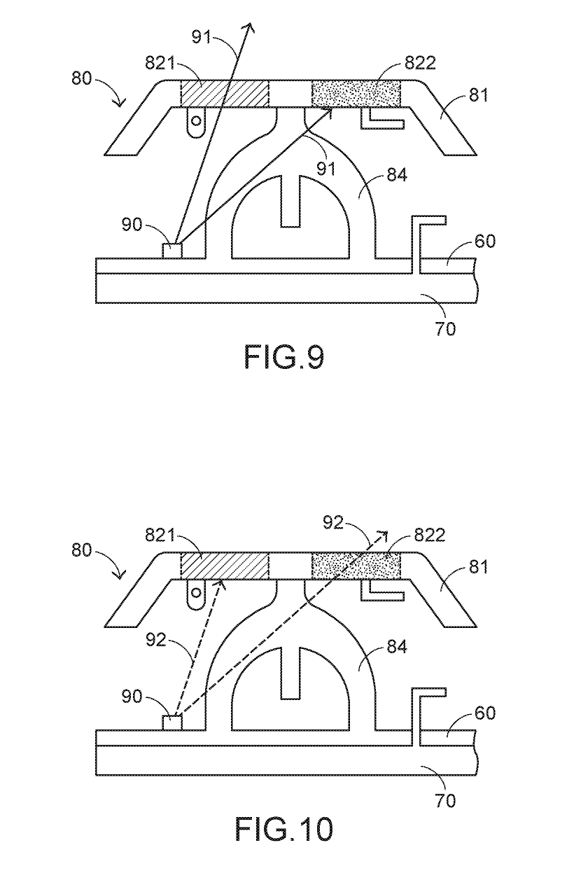

FIG. 9 schematically illustrates an optical path of the first color light corresponding to the key of the illuminated keyboard according to the second embodiment of the present invention. FIG. 10 schematically illustrates an optical path of the second color light corresponding to the key of the illuminated keyboard according to the second embodiment of the present invention. The bicolor light-emitting element 90 can selectively emit a first color light 91 or a second color light 92.

Please refer to FIG. 9. The first color light 91 emitted by the bicolor light-emitting element 90 travels to the keycap 81 in the upward direction. Then, the first color light 91 is outputted from the keycap 81 through the first color filtering pattern 821. Under this circumstance, the first color filtering pattern 821 is illuminated. Since the first color light 91 is not allowed to pass through the second color filtering pattern 822, the second color filtering pattern 822 is not illuminated. Please refer to FIG. 10. The second color light 92 emitted by the bicolor light-emitting element 90 travels to the keycap 81 in the upward direction. Then, the second color light 92 is outputted from the keycap 81 through the second color filtering pattern 822. Under this circumstance, the second color filtering pattern 822 is illuminated. Since the second color light 92 is not allowed to pass through the second color filtering pattern 822, the first color filtering pattern 821 is not illuminated.

In the above embodiment, the circuit layer 10 or 60 is a light-transmissible and transparent film layer. Consequently, the color light from the bicolor light-emitting element 40 or 90 can pass through the circuit layer 10 or 60. Moreover, the first color filtering pattern 321 and the second color filtering pattern 322 are formed on the keycap 31 by a bicolor spraying process or a bicolor injection molding process. Similarly, the first color filtering pattern 821 and the second color filtering pattern 822 are formed on the keycap 81 by a bicolor spraying process or a bicolor injection molding process. Preferably, the bicolor light-emitting element 40 or 90 is a bicolor light emitting diode.

From the above descriptions, the present invention provides a light color changeable illuminated keyboard. The user can switch the color light of the illuminated keyboard according to the practical requirements. Moreover, the character regions of the same key can be selectively illuminated or not illuminated. Consequently, the specified character regions can be recognized more easily.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A light color changeable illuminated keyboard, comprising:
a circuit layer;
a supporting plate located under the circuit layer;
plural keys located over the circuit layer and connected with the supporting plate, wherein each of the plural keys comprises a keycap, a light-transmission part, a connecting element and an elastic element, wherein the keycap is located over the circuit layer, the light-transmission part is formed on a top surface of the keycap, and the keycap is connected with the supporting plate through the connecting element;
a bicolor light-emitting element located below the key, and emitting a first color light or a second color light continuously, wherein the first color light or the second color light is outputted from the keycap through the light-transmission part;
a switching key disposed on the circuit layer to trigger the circuit layer to generate a pressing signal; and
a control unit electrically connected with the switching key and the bicolor light-emitting element, wherein when the pressing signal is received by the control unit, a switching signal is generated by the control unit and transmitted to the bicolor light-emitting element,
wherein if the switching key is pressed down when the first color light is continuously emitted by the bicolor light-emitting element, the pressing signal is transmitted from the switching key to the control unit, and the control unit generates the switching signal in response to the pressing signal, wherein in response to the switching signal, the bicolor light-emitting element stops emitting the first color light and emits the second color light continuously.

2. The light color changeable illuminated keyboard according to claim 1, wherein if the switching key is pressed down when the second color light is continuously emitted by the bicolor light-emitting element, the pressing signal is transmitted from the switching key to the control unit, and the control unit generates a restoring signal in response to the pressing signal, wherein in response to the restoring signal, the bicolor light-emitting element stops emitting the second color light but emits the first color light continuously.

3. The light color changeable illuminated keyboard according to claim 2, wherein if the control unit receives the pressing signal when the control unit detects that the first color light is continuously emitted by the bicolor light-emitting element, the control unit generates the switching signal, and the first color light is changed to the second color light in response to the switching signal, wherein if the control unit receives the pressing signal when the control unit detects that the second color light is continuously emitted by the bicolor light-emitting element, the control unit generates the restoring signal and the second color light is restored to the first color light in response to the restoring signal.

4. The light color changeable illuminated keyboard according to claim 1, wherein the first color light and the second color light have different colors.

5. The light color changeable illuminated keyboard according to claim 1, wherein the light-transmission part comprises a first color filtering pattern and a second color filtering pattern, wherein the first color light is outputted from the keycap through the first color filtering pattern, and the second color light is outputted from the keycap through the second color filtering pattern.

6. The light color changeable illuminated keyboard according to claim 5, wherein the first color light is not allowed to pass through the second color filtering pattern, and the second color light is not allowed to pass through the first color filtering pattern.

7. The light color changeable illuminated keyboard according to claim 5, wherein a color of the first color filtering pattern corresponds to a color of the first color light, and a color of the second color filtering pattern corresponds to a color of the second color light.

8. The light color changeable illuminated keyboard according to claim 5, wherein the first color filtering pattern and the second color filtering pattern are formed on the keycap by a bicolor spraying process.

9. The light color changeable illuminated keyboard according to claim 5, wherein the first color filtering pattern and the second color filtering pattern are formed on the keycap by a bicolor injection molding process.

10. The light color changeable illuminated keyboard according to claim 1, wherein the bicolor light-emitting element is located below the key and disposed on the circuit layer, wherein the first color light or the second color light travels in a direction from the circuit layer to the key, wherein after the first color light or the second color light passes through the light-transmission part, the first color light or the second color light is outputted from the keycap.

11. The light color changeable illuminated keyboard according to claim 1, further comprising a light guide plate, wherein the light guide plate is located under the supporting plate, wherein the first color light or the second color light emitted by the bicolor light-emitting element is introduced into the light guide plate and guided to a region under the key, wherein after the first color light or the second color light passes through the light-transmission part, the first color light or the second color light is outputted from the keycap.

12. The light color changeable illuminated keyboard according to claim 11, wherein the supporting plate comprises an opening, wherein after the first color light or the second color light passes through the opening, the first color light or the second color light passes through the keycap.

13. The light color changeable illuminated keyboard according to claim 1, wherein the bicolor light-emitting element is a bicolor light emitting diode.
